(19) United States
(12) Patent Application Publication
(10) Pub. No.: US 2020/0140343 A1
(43) Pub. Date: May 7, 2020

(54) CONCRETE CURING BLANKET WITH PH-INDICATOR

(71) Applicant: McTech Group, Inc., Hertford, NC (US)

(72) Inventor: Stephen F. McDonald, Hertford, NC (US)

(21) Appl. No.: 16/182,752

(22) Filed: Nov. 7, 2018

(51) Int. Cl. C04B 40/00; B32B 3/26; B32B 5/02; B32B 27/12; B32B 27/32; B32B 27/30; B32B 3/10; B28B 11/24; G01N 31/22

(52) U.S. Cl. CPC C04B 40/0096; B32B 3/266; B32B 5/022; B32B 27/12; B32B 27/32; B32B 2307/726; B32B 3/10; B28B 11/245; G01N 31/221; B32B 2307/7246; B32B 27/304

(57) ABSTRACT

A concrete curing blanket that includes a vapor barrier layer, a wicking layer, and pH-indicator, such as turmeric or Phenol Red incorporated into the concrete curing blanket. The pH-indicator may be a power or prills attached to the vapor barrier, the wicking layer, or another layer of the concrete curing blanket. Alternatively, the pH-indicator may be a series of ribbons or strips attached to the vapor barrier, the wicking layer, or another layer of the concrete curing blanket. As another alternative, the pH-indicator may be a matrix of discontinuous patches attached to the vapor barrier, the wicking layer, or another layer of the concrete curing blanket. As another alternative, the vapor barrier may include perforations.

### TECHNICAL FIELD

The present invention relates to concrete curing blankets and, more particularly, to a concrete curing blanket with a build-in pH-indicator.

### BACKGROUND

Portland cement and many other hydraulic-cement-based concretes are highly alkaline materials. The pH is a measure of hydrogen ion concentration indicating the acidity or alkalinity of a solution. Neutral solutions, such as distilled water, have a pH of 7. Values above 7 indicate solutions of increasing alkalinity, and values below 7 indicate solutions of increasing acidity. Because pH is a log scale based on 10, a solution with a pH of 3 has a hydrogen ion concentration 10 times that of a solution with a pH of 4, and 100 times that of a solution with a pH of 5. When Portland cement hydrates, the calcium silicates react to form calcium silicate hydrates and calcium hydroxide [Ca(OH)²]. The calcium hydroxide provides a substantial buffer for the pore solution, maintaining the pH level at approximately 12.6, which is that of the saturated Ca(OH)² solution. The pH can initially be higher than this value (typically up to 13.5) because of the presence of potassium and sodium hydroxides (KOH and NaOH), which are considerably more soluble than calcium hydroxide. These alkalis are present in limited quantities, however, and any carbonation or pozzolanic reaction rapidly reduces the pH to approximately 12.6.

In concrete terminology, carbonation is the reaction of carbon dioxide (CO2) in the atmosphere with alkaline components of the cement paste. Calcium compounds in the concrete produce calcium carbonate as a result of carbonation. Because the reaction proceeds in solution, the first indication of carbonation is a decrease in pH of the pore solution to 8.5. Carbonation generally proceeds in concrete as a front on the surface, beyond which the concrete is not affected and the pH is not reduced.

Depending on the actual chemistry of the Portland cement and amount of alkalis present, the pH of freshly placed concrete can vary from approximately 12 to over 13. The carbonation of concrete is known to lower the pH on the surface of the concrete slab to a value in the vicinity of 9. The pH of a concrete surface plays an important role in the selection of flooring adhesive and placement of flooring materials, especially with resilient flooring such as sheet vinyl. A concrete pH below 7.0 and above 10.0 is known to negatively affect resilient flooring, the adhesive used to attach the flooring to the concrete slab, or both. The flooring installer is typically tasked with cleaning and preparing the concrete slab surfaces prior to flooring installation. Pressure washing is typically not used to clean the concrete surface, as the high-pressure washing tends to saturate the concrete surface causing the flooring adhesive to fail due to excess slab moisture. Flooring installers often clean and scarify the concrete surface with sandpaper or shot-blast the surface. The process of sanding or shot blasting can remove the carbonated surface layer of concrete and expose a concrete surface that has higher pH.

Testing laboratories have reported concrete surface pH values as low as 6 or 7. But these measurements may be incorrect because the test method only measure the pH of water and readily-soluble materials on the concrete surface versus the true pH of the concrete slab. Incorrect pH test results can lead to the selection and use of an incompatible adhesive for the flooring, resulting in the risks of flooring failure. The concrete and flooring industries would therefore benefit from pH test methods that more accurately measures the pH of concrete surface.

Most flooring and adhesive manufacturers require pH testing of concrete surfaces because adhesives can degrade and lose strength when exposed to highly alkaline solutions such as concrete porewater. Some floor covering manufacturers suggest curing concrete by ponding water on the slab for 28 days. Others require 28 days of curing, but use the term “curing” to mean time after placement, regardless of the curing environment. The design team must understand that nothing is technically relevant about 28 days of curing, and the longer the concrete is kept moist, the longer it will take to dry. Also, ponding or adding water to the top of the slab certainly does not help the mixture water to evaporate faster. Additionally, curing water will infiltrate cracks and joints, wetting the bottom of the slab and making excessive curling more likely. Almost all manufacturers require that no curing compounds be used or that they be removed prior to adhesive application.

As a result, there is a persistent need for cost effective solution to measurement of the pH of curing concrete slabs.

### SUMMARY

The present invention meets the needs described above in concrete curing blanket with a build-in pH-indicator. The concrete curing blanket that includes a vapor barrier layer, a wicking layer, and pH-indicator, such as turmeric or Phenol Red incorporated into the concrete curing blanket. The pH-indicator may be a power or prills attached to the vapor barrier, the wicking layer, or another layer of the concrete curing blanket. Alternatively, the pH-indicator may be a series of ribbons or strips attached to the vapor barrier, the wicking layer, or another layer of the concrete curing blanket. As another alternative, the pH-indicator may be a matrix of discontinuous patches attached to the vapor barrier, the wicking layer, or another layer of the concrete curing blanket.

In view of the foregoing, it will be appreciated that concrete curing blanket with a build-in pH-indicator represent a significant improvement in concrete construction and, more particularly, in concrete blankets and pH monitoring. The foregoing relates only to the exemplary embodiments of the present invention, and that numerous changes may be made therein without departing from the spirit and scope of the invention as defined by the following claims.

### BRIEF DESCRIPTION OF THE FIGURES

FIG. 1 is a side view of a pH-indicating concrete curing blanket positioned on top of a curing concrete slab.

FIG. 2A is a side view of a first type of pH-indicating concrete curing blanket.

FIG. 2B is a side view of a second type of pH-indicating concrete curing blanket.

FIG. 3A is a top view of a first type of ph-indicating layer.

FIG. 3B is a top view of a second type of ph-indicating layer.

FIG. 3C is a top view of a third type of ph-indicating.

FIG. 4 is a logic flow diagram for fabricating a pH-indicating concrete curing blanket.

FIG. 5 is a logic flow diagram for constructing a concrete structure using the pH-indicating concrete curing blanket.

### DETAILED DESCRIPTION

Embodiments of the invention may be realized in concrete curing blanket with a build-in pH-indicator, such as an impregnated pH test strip, pH-indicator powder, or additive impregnated with a pH-indicator. The pH-indicating concrete curing blanket provides a method and device during concrete construction to monitor the reduction of alkalinity on the concrete surface on a continuous basis during the curing process. The addition of an embedded pH indicating strip, either of cellulose or clear poly carbonate, with multiple acid or alkaline indicators or a powered substance imbedded within the nonwoven absorptive layer, of either cellulose of rayon, that reacts to either acid or alkaline conditions. The pH-indicator provides the owner, designer, concrete contractor and the flooring supplier and installer with information to determine the rate and extent of surface carbonation occurring during the concrete curing process.

In general, a pH in the range of 7.0 to 7.7 indicates that the concrete slab has cured sufficiently to proceed with application of a floor covering or other surface preparation. The pH-indicator in the concrete curing blanket allows a person to determine at a glance when the concrete slab has reached the correct pH indicating that the slab has cured sufficiently to proceed with the floor covering. The pH-indicator provides an accurate indication of curing, which may save time over the conventional approach of simply waiting a predetermined time, such as 28 days or more before proceeding with floor covering or other surface preparation. The visual pH indicator may also indicate that the desired pH (typically 7.0-7.7) has not been reached after a usually sufficient time indicating that some corrective action is required, such as allowing additional curing time without rewetting, re-wetting and allowing additional time for curing, cleaning, sanding, shot blasting, or resurfacing all or a portion of the surface prior to adhering paint or a floor covering to the slab.

Turmeric is yellow in acid and neutral substances that turns bright red hen it interacts with bases. The phenol red fermentation medium contains peptone, phenol red (a pH-indicator) and the carbohydrate to be tested. Phenol red is yellow at a pH below about 6.8 and red at a pH above about 7.4. Any suitable pH-indicator may be used, such as any commercially available pH test strip or other pH-indicator. For example, multiple acid or alkaline indicators or a powered pH indicating substance may be used, such as but not limited to turmeric or Phenol red. The pH-indicator may be included in a separate layer included of the blanket, embedded into a super absorbent additive or other component of the blanket, embedded into or attached to a nonwoven fabric layer, embedded into or attached to a wicking layer, or embedded into or attached to the vapor barrier layer. As specific examples, the pH-indicator may be embedded into or attached to any layer of the concrete curing blanked described in U.S. Pat. No. 7,572,525, which is incorporated by reference. A concrete curing blanket is typically fabricated by air-laying a wicking material onto a vapor barrier material, and then applying heat and pressure to combine the layers into a blanket, for example by passing the combined layers through heated calendar roils. The vapor barrier may be polyethylene, PVC or other sheet material that is impervious to water vapor. The wicking material may include paper pulp manufactured through the Kraft process. Other materials may be added to the basic wicking and vapor barrier materials as ingredients of these layers or as separate layers. For example, the blanket may also include one or more non-snag scrim layers, binding agents, super-absorbent materials, pigments, and so forth.

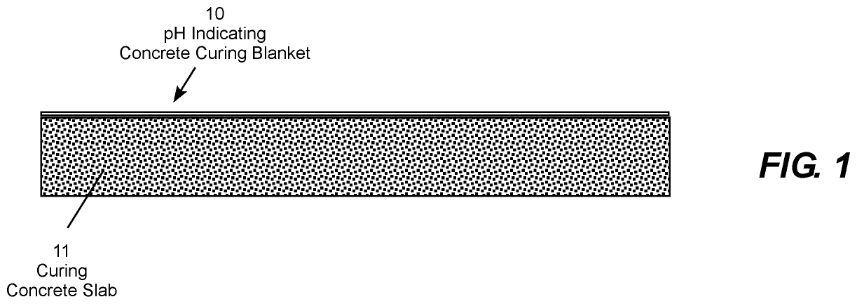

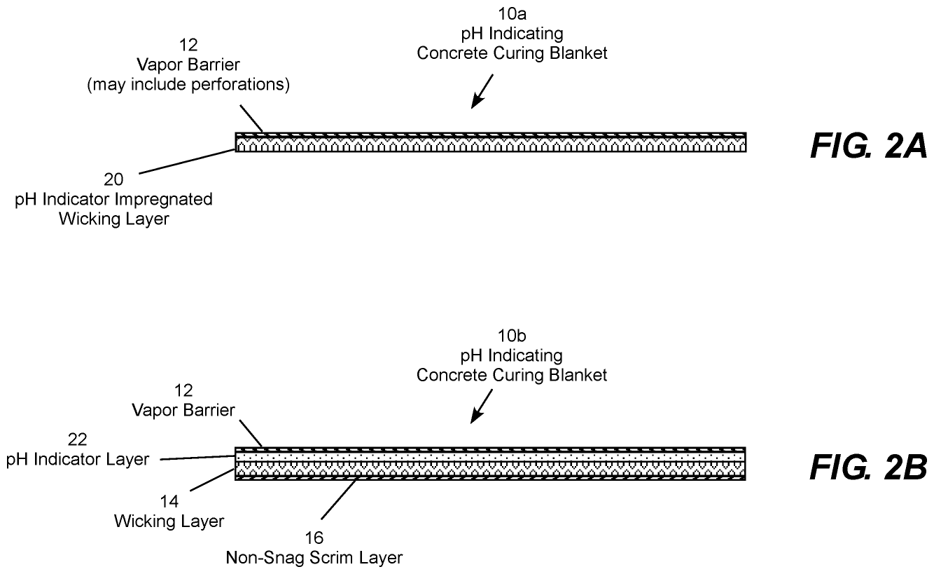

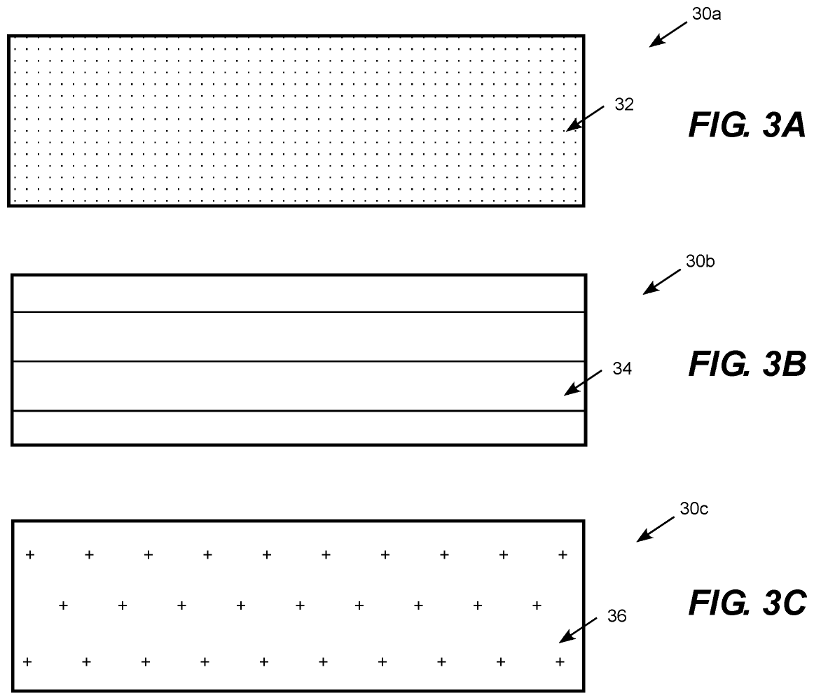

FIG. 1 is a side view of a pH-indicating concrete curing blanket 10 positioned on top of a curing concrete slab 11. The pH-indicator may be embedded in the concrete curing blanket 10 in a variety of ways, as represented by FIGS. 2A-2B and FIGS. 3A-3C. Any suitable pH-indicator may be used in any of the embodiments.

FIG. 2A is a side view of a first type of pH-indicating concrete curing blanket 10a that includes a vapor barrier layer 12 and a wicking layer 20 that is impregnated with the pH-indicator, such as a powder to gel-coated prills distributed throughout the wicking layer 20. The curing blanket 10a is a multi-layer blanket with a few as two layers including the vapor barrier layer 12 and the pH-indicator impregnated wicking layer 20. Additional layers may be included as a matter of design choice. For example, a non-snag scrim layer may be included under the pH-indicator impregnated wicking layer 20. As another option, the vapor barrier layer 12 may be perforated to facilitate re-wetting of the underlying concrete sab through the vapor barrier by spraying water onto the top of the concrete curing blanket. For example, the vapor barrier layer 12 may include small pin holes (e.g., 0.01 to 0.05 inches) every two to four inches. This allows the wicking layer 20 to spread the water introduced through the perforations throughout the wicking layer to cover the entire surface of the concrete slab. This is a technique often sought by Departments of Transportation and for high performance concrete.

FIG. 2B is a side view of a second type of pH-indicating concrete curing blanket 10b in which the pH-indicator is included in a separate pH-indicator layer 22 positioned between a vapor barrier layer 12 and a wicking layer 14. In this embodiment, the pH-indicator layer 22 is typically adhered to vapor barrier layer 12 or a wicking layer 14. The pH-indicator layer 22 may be continuous and coextensive with the other layers 12 and 14, or it may be discontinuous, such as a series of strips, dots or patches spaced apart throughout the blanket. The discontinuous pH-indicators may be attached directly to the vapor barrier layer 12, to the wicking layer 14, to a dedicated carrier layer, or to another layer of the blanket. The pH-indicator comprises a power or prills comprising a pH-indicating material dispersed throughout the wicking layer. Additional ingredients and layers may be included as a matter of design choice. For example, binding agents, super-absorbent materials, and pigments may also be included in the wicking layer or in separate layers. In addition, a non-snag scrim layer 16 may be positioned under the wicking layer 14.

FIG. 3A is a top view of a first type of pH-indicating layer 30a in which a pH-indicator 32 is dispersed throughout a substrate layer, such as the vapor barrier layer, the wicking layer, a carrier layer, or another layer of the blanket. In this example, the pH indicating material may be a powder, prills or dots dispersed throughout a substrate layer.

FIG. 3B is a top view of a second type of ph-indicating layer 30b in which a pH-indicator 34 is configured as a series of ribbons or strips attached to the vapor barrier layer, the wicking layer, a carrier layer, or another layer of the blanket. In this example, the pH-indicator may be continuous pH-indicator ribbons or strips carrying the pH-indicator material.

FIG. 3C is a top view of a third type of ph-indicating layer 30c in which a pH-indicator 36 is configured as a matrix of patches attached to the vapor barrier layer, the wicking layer, a carrier layer, or another layer of the blanket. In this example, the pH-indicator may be discontinuous pH-indicator cross-shaped patches carrying the pH-indicator material.

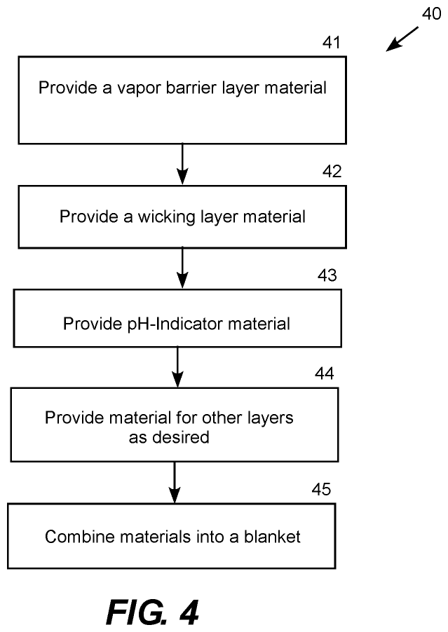

FIG. 4 is a logic flow diagram for fabricating a pH-indicating concrete curing blanket. Step 41 includes providing a vapor barrier material, step 42 includes providing a wicking layer material, and step 43 includes providing a pH-indicator material. Step 44 includes combining the vapor barrier layer material, the wicking layer material, and the pH-indicator material into a blanket. For example, the wicking layer material may be impregnated with the pH-indicator material and air-laid onto the vapor barrier material. The combined layers are then compressing under heat and pressure, for example by passing the combined layers through heated calendar rolls. As another example, the pH-indicator material may be adhered to the vapor barrier material. The wicking material may then be air-laid onto the vapor barrier material. The combined layers are then compressing under heat and pressure. As a third example, the pH-indicator material may be adhered to a carrier layer material. The wicking material may then be air-laid onto the vapor barrier material. The vapor barrier layer, the wicking layer, and the carrier layer are then compressing under heat and pressure.

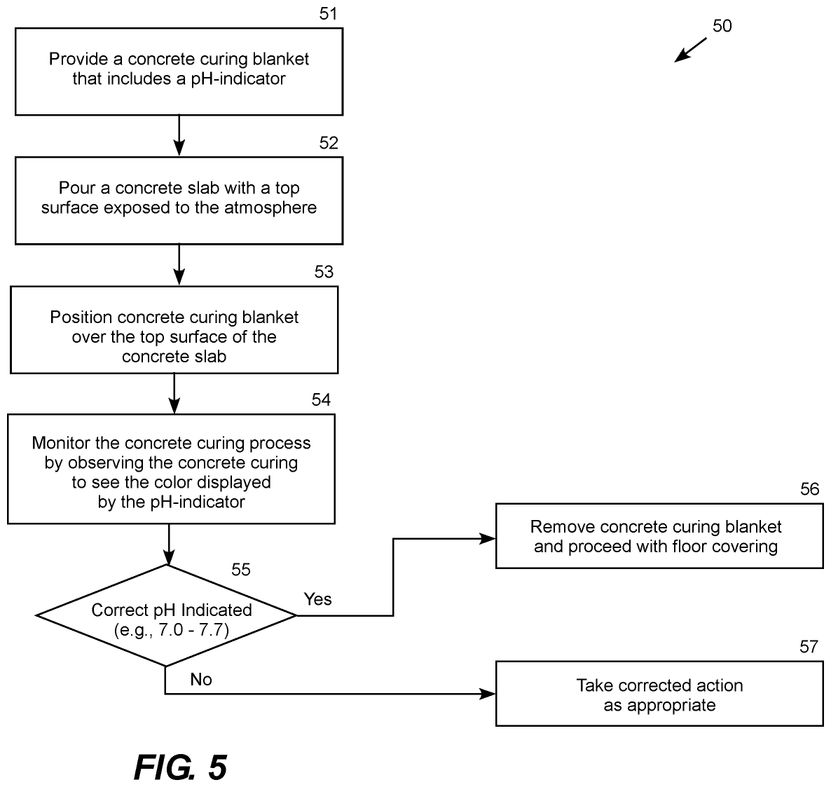

FIG. 5 is a logic flow diagram 50 for constructing a concrete structure using the pH-indicating concrete curing blanket. In step 51, concrete curing blanket including a pH-indicator is provided. Step 51 is followed by step 52, in which a concrete slap is poured with a trop surface exposed to the atmosphere. Step 52 is followed by step 53, in which the concrete curing blanket is positioned on the top surface of the concrete slab, typically by unrolling the blanket onto the top surface of the slab within the first hour after pouring and leveling the slab. Step 53 is followed by step 54, in which a person monitors the concrete curing process by periodically observing the concrete curing blanket to see the color displayed by the pH-indicator. Step 54 is followed by step 55, in which a person visually inspects the color of the concrete curing blanket to determine whether the surface of the slab has reached the correct pH (typically 7.0-7.7). If the pH-indicator is the color indicating that the surface of the slab has reached the correct pH, the “yes” branch is followed from step 55 to step 56, in which the concrete curing blanket is removed and floor covering may proceed. If, on the other hand, the correct pH has not been reached in a usually sufficient time, the “no” branch is is follower from step 55 to step 57, in which corrective action may be taken, such as allowing additional curing time without rewetting, re-wetting and allowing additional time for curing, cleaning, sanding, shot blasting, or resurfacing all or a portion of the surface prior to adhering paint or a floor covering to the slab. In some cases, the concrete mixture may be adjusted to avoid similar problems going forward. In extreme cases, the slab may have to be removed and replaced.

Although the concrete curing blankets with build-in pH-indicators have been illustrated in the context of horizontal concrete slabs in road construction, it will be appreciated that the dowel basket is well adapted for but not limited to the road construction application and can be used for any concrete slab regardless of its intended purpose or orientation. For example, the invention is equally applicable to joints in concrete sidewalks, building floors, walls, ceilings, abutments and other structures. Those skilled in the art will appreciate that the foregoing describes preferred embodiments of the invention and that many adjustments and alterations will be apparent to those skilled in the art within the spirit and scope of the invention as defined by the appended claims.

1. A concrete curing blanket comprising a pH-indicator, comprising:
a vapor barrier layer;
a wicking layer; and
a pH-indicator dispersed throughout the wicking layer.

2. The concrete curing blanket of claim 1, wherein the pH-indicator comprises turmeric.

3-5. (canceled)

6. The concrete curing blanket of claim 1, wherein the pH-indicator comprises phenol red.

7. The concrete curing blanket of claim 1, wherein the vapor barrier layer includes perforations.

8-20. (canceled)

21. The concrete curing blanket of claim 1, wherein the pH-indicator comprises a powder.

22. The concrete curing blanket of claim 1, wherein the pH-indicator comprises prills.

23. The concrete curing blanket of claim 1, further comprising a non-snag scrip layer.

24. The concrete curing blanket of claim 23, wherein the pH-indicator comprises a powder.

25. The concrete curing blanket of claim 24, wherein the pH-indicator comprises turmeric.

26. The concrete curing blanket of claim 24, wherein the pH-indicator comprises phenol red.

27. The concrete curing blanket of claim 23, wherein the pH-indicator comprises prills.

28. The concrete curing blanket of claim 27, wherein the pH-indicator comprises turmeric.

29. The concrete curing blanket of claim 27, wherein the pH-indicator comprises phenol red.
